(19) United States
(12) Patent Application Publication
(10) Pub. No.: US 2026/0079378 A1
(43) Pub. Date: Mar. 19, 2026

(54) ULTRA-LOW NOISE QUANTUM FREQUENCY CONVERSION FOR TRAPPED ION QUANTUM NETWORK

(71) Applicant: University of Maryland, College Park, College Park, MD (US)

(72) Inventors: Uday SAHA, College Park, MD (US); Edo WAKS, Washington, DC (US)

(21) Appl. No.: 19/110,651

(22) PCT Filed: Sep. 11, 2023
(86) PCT No.: PCT/US2023/073839

§ 371 Date: Mar. 11, 2025

Related U.S. Application Data
(60) Provisional application No. 63/375,363, filed on Sep. 12, 2022.

(51) Int. Cl. G02F 1/35; G02F 1/365; H04B 10/70

(52) U.S. Cl. CPC G02F 1/3507; G02F 1/3503; G02F 1/365; H04B 10/70; G02F 2203/13

(57) ABSTRACT

A system includes a trapped ion, a single-photon source, or a quantum emitter configured to emit a first entangled photon and a plurality of quantum frequency conversion stages configured to convert the first entangled photon to a telecommunication photon (1260 nm to 1675 nm). Each quantum frequency conversion stage includes a corresponding pump laser, configured to interact with an incoming photon, that creates an output photon having a frequency that is at least 12 THz higher than a frequency of the pump laser, such that each quantum frequency conversion stage has a signal-to-noise ratio (SNR) of at least 1. Advantageously the system can provide an ultra-low noise quantum frequency conversion scheme to generate telecommunication photons (1260 nm to 1675 nm) entangled with photons from a quantum source (e.g., trapped ion, single-photon source, quantum emitter), a high signal integrity, and scalable long-distance telecommunication quantum networks.

### CROSS-REFERENCE TO RELATED APPLICATION

This application claims priority to U.S. Provisional Application No. 63/375,363, filed Sep. 12, 2022, which is hereby incorporated herein in its entirety by reference.

This invention was made with government support under contract OIA2134891 awarded by the National Science Foundation (NSF). The government has certain rights in the invention.

### FIELD

The present disclosure relates to quantum network apparatuses, systems and methods, for example, low-noise quantum modem apparatuses, systems, and methods based on quantum frequency conversion to generate telecommunication photons.

### BACKGROUND

Quantum computing, simulation, and communication platforms based on trapped ions are at the forefront of quantum information science. Trapped ion systems are well suited for quantum networking, given their long coherence times, high single and two-qubit gate fidelities, and their ability to emit photons entangled with the trapped ion's internal states.

Of particular interest are photons produced via S-P dipole transitions, enabling direct entanglement between the photons and commonly used ground-state qubits of ions, for example, ytterbium ions (Yb⁺), barium ions (Ba⁺), and strontium ions (Sr⁺). Ground-state qubits currently demonstrate the longest coherence times in trapped ions, as well as leading two-qubit gate fidelities.

However, trapped ion quantum networks have been limited in range due to photon emission at ultra-violet (UV) and visible wavelengths, where light suffers large fiber-optic propagation losses. Additionally, this prevents the integration of these networks into existing telecommunications infrastructure.

### SUMMARY

Accordingly, there is a need to develop a quantum modem to provide an ultra-low noise quantum frequency conversion scheme to generate telecommunication photons (e.g., 1260 nm to 1675 nm) entangled with photons from a quantum source (e.g., trapped ion, single-photon source, quantum emitter), wavelength conversion of photons emitted from the quantum source into telecommunication band wavelengths (e.g., 1260 nm to 1675 nm) for use in optical communication fibers, a high signal integrity, and/or scalable long-distance telecommunication quantum networks.

In some embodiments, a system can include a quantum source, a first pump laser, a first quantum frequency conversion device, a second pump laser, and a second quantum frequency conversion device. In some embodiments, the quantum source can be configured to emit first entangled photons. In some embodiments, the quantum source can include a trapped ion, a single-photon source, or a quantum emitter. In some embodiments, the first pump laser can be configured to supply second photons. In some embodiments, the first quantum frequency conversion device can include a first non-linear medium. In some embodiments, the first quantum frequency conversion device can be configured to interact second photons with one of the first entangled photons in the first non-linear medium to create a third photon which is entangled with the first entangled photon. In some embodiments, the third photon can have a longer wavelength than the first entangled photons. In some embodiments, the second pump laser can be configured to supply fourth photons. In some embodiments, the second quantum frequency conversion device can include a second non-linear medium. In some embodiments, the second quantum frequency conversion device can be configured to interact fourth photons with the third photon in the second non-linear medium to create a fifth photon which is entangled with the third photon. In some embodiments, the fifth photon can have a longer wavelength than the third photon. In some embodiments, the fifth photon can have a wavelength in the telecommunication range (1260 nm to 1675 nm). In some embodiments, a signal-to-noise ratio (SNR) of the fifth photon upon exiting the second quantum frequency conversion device can be at least 1.

In some embodiments, the signal-to-noise ratio (SNR) of the fifth photon is at least 30. In some embodiments, the signal-to-noise ratio (SNR) of the fifth photon is at least 60. In some embodiments, the signal-to-noise ratio (SNR) of the fifth photon is at least 100. In some embodiments, the signal-to-noise ratio (SNR) of the fifth photon is in a range of about 110 to about 165. In some embodiments, the fifth photon upon exiting the second quantum frequency conversion device can have a high signal integrity. For example, the fifth photon can have a high signal quality, a high fidelity, and/or a high signal-to-noise ratio (SNR).

In some embodiments, an output of the second quantum frequency conversion device can include the fifth photon and one or more noise photons. In some embodiments, a source of the noise photons can include unconverted signal photons, Raman anti-Stokes noise photons, and photons from the first and second pump lasers.

In some embodiments, the system can further include an optical filter, a short pass filter, a long pass filter, a band pass filter, or a combination of filters configured to remove noise photons. In some embodiments, the system can further include a short pass optical filter configured to remove noise photons associated with the second pump laser. In some embodiments, the system can further include a long pass filter configured to remove noise photons associated with the first pump laser and the first quantum frequency conversion device. In some embodiments, the system can further include one or more band pass filters configured to remove noise photons. For example, the one or more band pass filters can include a tunable filter configured to remove noise photons associated with Raman anti-Stokes noise photons.

In some embodiments, the frequency of the fifth photon can be at least 10 THz higher than a frequency of the second pump laser to reduce interference with Raman anti-Stokes noise photons.

In some embodiments, the first non-linear medium can include a first waveguide in a Sagnac interferometer configuration configured to convert both orthogonal polarizations of the third photon. In some embodiments, the first non-linear medium can include a first waveguide configured to convert one of the orthogonal polarizations of the third photon. In some embodiments, the first waveguide can include a periodically poled lithium niobate (PPLN) waveguide. In some embodiments, the second non-linear medium can include a second waveguide configured to convert one of the orthogonal polarizations of the fifth photon. In some embodiments, the second non-linear medium can include a second waveguide in a Sagnac interferometer configuration configured to convert both orthogonal polarizations of the fifth photon. In some embodiments, the second waveguide can include a PPLN waveguide.

In some embodiments, a wavelength of the first entangled photons can be in the ultraviolet and visible regime of the electromagnetic spectrum. In some embodiments, a wavelength of the first entangled photons can be in the visible regime of the electromagnetic spectrum. In some embodiments, a wavelength of the first entangled photons can be in the ultraviolet regime of the electromagnetic spectrum.

In some embodiments, the fifth photon can be configured to transmit quantum information a distance of at least one meter. In some embodiments, the fifth photon can be configured to transmit quantum information a distance of at least 10 meters. In some embodiments, the fifth photon can be configured to transmit quantum information a distance of at least 100 meters. In some embodiments, the fifth photon can be configured to transmit quantum information a distance of at least one kilometer. In some embodiments, the fifth photon can be configured to transmit quantum information a distance in a range of about one meter to about one kilometer.

In some embodiments, the fifth photon can be entangled with the emitted first entangled photon. In some embodiments, temporal pulse shapes of the first entangled photons and the fifth photon can overlap within experimental uncertainties.

In some embodiments, the first quantum frequency conversion device can be configured to create the third photon through difference frequency generation between the first entangled photon and second photons in the first non-linear medium. In some embodiments, the second quantum frequency conversion device can be configured to create the fifth photon through difference frequency generation between the third photon and fourth photons in the second non-linear medium.

In some embodiments, the system can be configured to provide an interface between a quantum computer and a fiber-optic network.

In some embodiments, the trapped ion can include barium (Ba⁺), ytterbium (Yb⁺), strontium (Sr⁺), calcium (Ca⁺), or mercury (Hg⁺).

In some embodiments, the system can further include a high pass filter between the second pump laser and the second quantum frequency conversion device.

In some embodiments, a method of generating entangled photons with wavelengths in the telecommunication range can include generating first entangled photons from a trapped ion, a single-photon source, or a quantum emitter. In some embodiments, the method can further include interacting one of the first entangled photons with second photons of a first pump laser in a first non-linear medium of a first quantum frequency conversion device, thereby generating a third photon having a longer wavelength than the first entangled photons. In some embodiments, the method can further include interacting the third photon with fourth photons of a second pump laser in a second non-linear medium of a second quantum frequency conversion device, thereby generating a fifth photon having a longer wavelength than the third photon. In some embodiments, a wavelength of the fifth photon can be in the telecommunication range (1260 nm to 1675 nm). In some embodiments, a signal-to-noise ratio (SNR) of the fifth photon upon exiting the second quantum frequency conversion device can be at least 1.

In some embodiments, the method can further include filtering the fifth photon to reduce one or more noise photons. In some embodiments, the source of the noise photons can include unconverted signal photons, Raman anti-Stokes noise photons, and photons from the first and second pump lasers.

In some embodiments, a quantum network can include two or more quantum computers, two or more quantum modems, and a quantum router. In some embodiments, each quantum computer can be separated from another quantum computer in the quantum network by a distance of at least one meter. In some embodiments, each quantum modem can be coupled to a quantum computer. In some embodiments, each quantum modem can be configured to convert emitted entangled photons produced by the quantum computer into telecommunication photons (1260 nm to 1675 nm) through one or more quantum frequency conversion devices. In some embodiments, the quantum router can be configured to couple one quantum computer and quantum modem to another quantum computer and quantum modem through optical telecommunication fibers. In some embodiments, the telecommunication photons have a signal-to-noise ratio (SNR) of at least 1.

In some embodiments, the quantum network can be configured for distributed quantum computing between the two or more quantum computers. In some embodiments, in each quantum frequency conversion device a corresponding pump laser, configured to interact with an incoming photon in a non-linear medium, creates an output photon having a frequency that is at least 12 THz higher than a frequency of the pump laser.

In some embodiments, a system can include a quantum source and a plurality of quantum frequency conversion stages. In some embodiments, the quantum source can be configured to emit a first entangled photon. In some embodiments, the quantum source can include a trapped ion, a single-photon source, or a quantum emitter. In some embodiments, the plurality of quantum frequency conversion stages can be configured to convert the first entangled photon to a telecommunication photon (1260 nm to 1675 nm). In some embodiments, in each quantum frequency conversion stage a corresponding pump laser, configured to interact with an incoming photon in a non-linear medium, creates an output photon having a frequency that is at least 12 THz higher than a frequency of the pump laser. In some embodiments, each quantum frequency conversion stage has a signal-to-noise ratio (SNR) of at least 1.

In some embodiments, the telecommunication photon can be configured to propagate through optical telecommunication fibers.

In some embodiments, a quantum modem for a trapped ion quantum computer can convert a wavelength of an emitted photon from a visible wavelength to an O-band telecommunication wavelength (1260 nm to 1360 nm). In some embodiments, the quantum modem can be coupled to a quantum computer. In some embodiments, the quantum modem can include one or more quantum frequency conversion devices and one or more filters configured to remove noise photons from the system. In some embodiments, in a first quantum frequency conversion stage, a 493 nm photon can be converted to a 781 nm photon through difference frequency conversion using a 1342 nm pump laser in a first non-linear medium (e.g., first PPLN waveguide). In some embodiments, in a second quantum frequency conversion stage, 1287 nm photons can be created through difference frequency generation between 781 nm photons and a 1990 nm pump laser in a second non-linear medium (e.g., second PPLN waveguide). In some embodiments, multiple filters can remove noise photons due to the pump lasers, Raman anti-Stokes noise photons, and unconverted photons. In some embodiments, the wavelength of the 1990 nm pump laser is chosen such that Raman anti-Stokes noise photons do not overlap with the 1287 nm O-band telecommunication photons. In some embodiments, the generated O-band telecommunication photons can have signal-to-noise ratios between 110 and 165.

In some embodiments, a 493 nm visible light photon emitted from a trapped barium ion (Ba⁺) can undergo two stages of quantum frequency conversion to generate a 1287 nm telecommunication O-band photon. In some embodiments, 493 nm emitted photons can undergo a first quantum frequency conversion. In some embodiments, 493 nm emitted photons and photons from a 1342 nm pump laser can undergo difference frequency conversion in a first quantum frequency conversion device (e.g., non-linear medium) to generate 781 nm photons. In some embodiments, a first quantum frequency conversion device can include a Sagnac interferometer configuration.

In some embodiments, 781 nm photons can undergo a second quantum frequency conversion. In some embodiments, 781 nm photons and photons from a 1990 nm pump laser interact through difference frequency conversion in a second quantum frequency conversion device (e.g., non-linear medium) to generate 1287 nm telecommunication photons. In some embodiments, a second quantum frequency conversion device can include a PPLN waveguide. In some embodiments, 1990 nm light from a pump laser can be filtered through two high pass filters before entering the second quantum frequency conversion device. In some embodiments, the wavelength of light from the second pump laser is chosen such that Raman anti-Stokes noise photons from the pump laser do not overlap with the converted 1287 nm telecommunication photons.

In some embodiments, photons exiting the second quantum frequency conversion device can be filtered to remove noise photons. In some embodiments, a 1326 nm short pass optical filter can be used to block the 1990 nm pump laser and separate 1287 nm photons. In some embodiments, a 1000 nm long pass optical filter can be used to eliminate unconverted 781 nm photons and noise photons coming from the first quantum frequency conversion device. In some embodiments, a tunable filter, for example, with a bandwidth of 18 GHz, can be used to reduce the Raman anti-Stokes noise photons coming from the second quantum frequency conversion device.

Implementations of any of the techniques described above can include a system, a method, a process, a device, and/or an apparatus. The details of one or more implementations are set forth in the accompanying drawings and the description below. Other features will be apparent from the description and drawings, and from the claims.

Further features and exemplary aspects of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the embodiments and, together with the description, further serve to explain the principles of the embodiments and to enable a person skilled in the relevant art(s) to make and use the embodiments.

FIG. 1 is a schematic illustration of a quantum modem, according to an exemplary embodiment.

FIG. 2 is a plot of quantum conversion efficiency as a function of pump power for a second quantum frequency conversion device, according to an exemplary embodiment.

FIG. 3 is a plot of noise counts as a function of pump power for a second quantum frequency conversion device, according to an exemplary embodiment.

FIG. 4 is a schematic illustration of a quantum modem detection system, according to an exemplary embodiment.

FIG. 5 is a plot of time resolved O-band photon counts, according to an exemplary embodiment.

FIG. 6 is a plot of temporal pulse shapes for a 493 nm photon and a 1287 nm converted photon, according to an exemplary embodiment.

FIG. 7 is a plot of second-order intensity correlation between the 493 nm photon and the 1287 nm converted photon, according to an exemplary embodiment.

FIG. 8 is a schematic illustration of a second quantum frequency conversion by difference frequency generation (DFG), according to an exemplary embodiment.

FIG. 9 is a schematic illustration of a trapped ion stage timing sequence, according to an exemplary embodiment.

FIG. 10 is a plot of time resolved 493 nm photon counts, according to an exemplary embodiment.

FIG. 11 is a schematic illustration of an energy diagram of an S-P dipole transition in a trapped ion (¹³⁸Ba⁺), according to an exemplary embodiment.

FIG. 12 is a schematic illustration of a quantum network, according to an exemplary embodiment.

FIG. 13 is a schematic illustration of a quantum internet, according to an exemplary embodiment.

The features and exemplary aspects of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This specification discloses one or more embodiments that incorporate the features of this present disclosure. The disclosed embodiment(s) merely exemplify the present disclosure. The scope of this disclosure is not limited to the disclosed embodiment(s). The present disclosure is defined by the claims appended hereto.

The embodiment(s) described, and references in the specification to “one embodiment,” “an embodiment,” “an example embodiment,” “some embodiments,” etc., indicate that the embodiment(s) described can include a particular feature, structure, and/or characteristic, but every embodiment may not necessarily include the particular feature, structure, and/or characteristic. Moreover, such phrases are not necessarily referring to the same embodiment. Further, when a particular feature, structure, and/or characteristic is described in connection with an embodiment, it is understood that it is within the knowledge of one skilled in the art(s) to effect such feature, structure, and/or characteristic in connection with other embodiments whether or not explicitly described.

Spatially relative terms, such as “beneath,” “below,” “lower,” “above,” “on,” “upper,” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (rotated 90 degrees or at other orientations) and the spatially relative descriptors used herein may likewise be interpreted accordingly.

The term “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM), random access memory (RAM), magnetic disk storage media, optical storage media, flash memory devices, and/or electrical, optical, acoustic, or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, and/or other devices executing the firmware, software, routines, instructions, etc.

The term “noise photon” or “noise photons” as used herein indicates unconverted signal photons (e.g., from quantum source), Raman anti-Stokes noise photons (e.g., due to Raman scattering processes), and/or photons from one or more pump lasers.

### Exemplary Quantum Modems

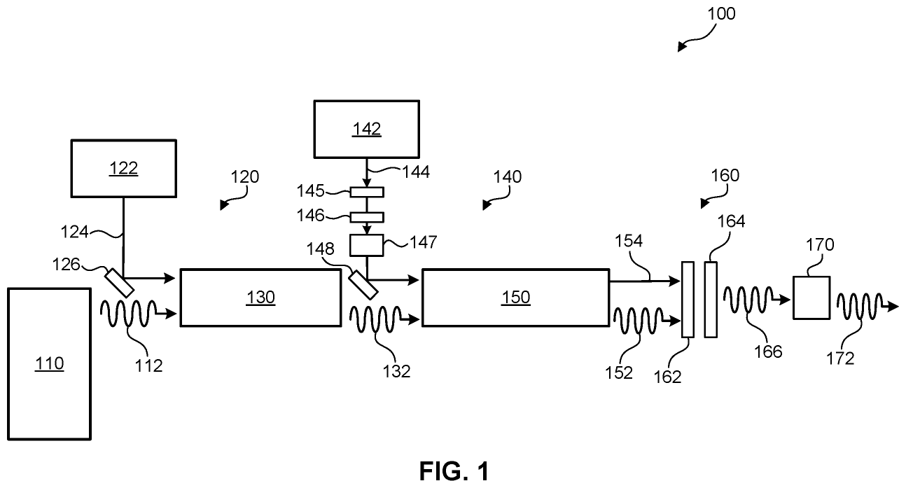

FIG. 1 illustrates a quantum modem 100, according to various exemplary embodiments. Quantum modem 100 can include a trapped ion stage 110, a first quantum frequency conversion stage 120, a second quantum frequency conversion stage 140, and a background filter stage 160.

As shown in FIG. 1, a photon 112 (e.g., entangled) can be emitted from a trapped ion in trapped ion stage 110. In some embodiments, photon 112 can include a wavelength of 493 nm. In some embodiments, photon 112 can be emitted from a quantum source, including but not limited to, a trapped ion, a single-photon source, or a quantum emitter.

In first quantum frequency conversion stage 120, photon 112 interacts with first pump laser light 124 inside first quantum frequency conversion device 130 (e.g., a non-linear medium) to generate photon 132. In some embodiments, photon 112 and first pump laser light 124 can interact in the non-linear medium (e.g., a waveguide) to generate photon 132 through difference frequency conversion. In some embodiments, photon 132 can have a wavelength of 781 nm. In some embodiments, generated photon 132 can be entangled with photon 112.

In some embodiments, first pump laser light 124 can be generated by first pump laser 122 and can reflect from first dichroic mirror 126 before entering first quantum frequency conversion device 130. In some embodiments, generated photon 132 can have a frequency that is at least 12 THz higher than a frequency of first pump laser light 124.

In some embodiments, first quantum frequency conversion device 130 can include a Sagnac interferometer configuration. In some embodiments, first quantum frequency conversion device 130 can include a periodically poled lithium niobate (PPLN) waveguide. In some embodiments, first quantum frequency conversion device 130 can have a signal-to-noise (SNR) of at least 1.

In second quantum frequency conversion stage 140, photon 132 and second pump laser light 144 can interact in second quantum frequency conversion device 150 (e.g., a non-linear medium) to generate photon 152. In some embodiments, photon 132 and second pump laser light 144 can interact in the non-linear medium (e.g., a waveguide) to generate photon 152 through difference frequency conversion. In some embodiments, photon 152 can have a wavelength of 1287 nm. In some embodiments, generated photon 152 can be entangled with photon 112 and photon 132.

In some embodiments, second pump laser 142 can generate second pump laser light 144. As shown in FIG. 1, second pump laser light 144 can pass through first high pass filter 145 and second high pass filter 146. In some embodiments, first high pass filter 145 and second high pass filter 146 can be configured to remove noise from second pump laser light 144. In some embodiments, second pump laser light 144 can also pass through polarization control 147 before it is reflected from dichroic mirror 148 into second quantum frequency conversion device 150. In some embodiments, generated photon 152 can have a frequency that is at least 12 THz higher than a frequency of second pump laser light 144.

In some embodiments, second quantum frequency conversion device 150 can include a Sagnac interferometer configuration. In some embodiments, second quantum frequency conversion device 150 can include a PPLN waveguide. In some embodiments, second quantum frequency conversion device 150 can have a signal-to-noise (SNR) of at least 1.

In some embodiments, background filter stage 160 can be configured to filter noise photons 154 from frequency converted photons 152. Noise photons 154 can include second pump laser light 144, photons 132 that do not efficiently undergo second quantum frequency conversion stage 140, and/or Raman anti-Stokes noise photons.

Background filter stage 160 can include a low pass filter 162, a high pass filter 164, and/or tunable filter 170. In some embodiments, low pass filter 162 can be configured to block photons with wavelengths greater than 1326 nm, for example, first pump laser light 124 and/or second pump laser light 144. In some embodiments, high pass filter 164 can be configured to block photons with wavelengths less than 1000 nm, for example, photons 112 and/or photons 132.

As shown in FIG. 1, filtered O-band photons 166 can pass through a tunable filter 170, resulting in tuned O-band photons 172. In some embodiments, tunable filter 170 is configured to reduce Raman anti-Stokes noise photons. In some embodiments, tunable filter 170 can have a bandwidth of 18 GHz. In some embodiments, quantum modem 100 can convert photon 112 from a quantum source (e.g., trapped ion, single-photon source, quantum emitter) into a telecommunication photon (e.g., 1260 nm to 1675 nm). In some embodiments, tuned O-band photons 172 can have a wavelength in a telecommunication band (e.g., 1260 nm to 1675 nm), for example, the O-band (1260 nm to 1360 nm), the C-band (1530 nm to 1565 nm), and/or the E-band (1360 nm to 1460 nm).

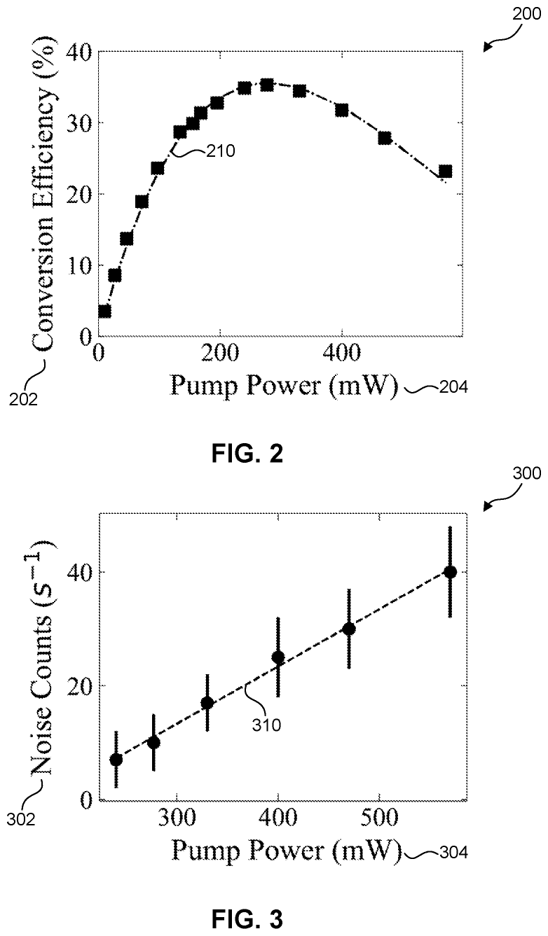

FIG. 2 illustrates conversion efficiency plot 200 of a photon during a second quantum frequency conversion as a function of pump power, according to some embodiments. For example, FIG. 2 illustrates the conversion efficiency of photon 132 in second quantum frequency conversion device 150 as a function of power of second pump laser 142. In a quantum frequency conversion device, only a percentage of incoming photons successfully undergo frequency conversion. Pump laser power is one variable that can determine conversion efficiency. As shown in conversion efficiency plot 200, conversion efficiency percentage 202 depends on pump power 204 according to data fit 206. In some embodiments, data fit 206 can be defined as η sin²(π/2P/Pₘ) where η is the photon conversion efficiency (%), P is the pump power, and Pₘ is the pump power at a peak conversion efficiency of η (e.g., 35.6% at a pump power of 278 mW).

FIG. 3 illustrates noise-power plot 300 of noise counts as a function of pump power during a second quantum frequency conversion, according to some embodiments. Noise-power plot 300 shows noise counts 302 as a function of pump power 304. In some embodiments, noise counts 302 and pump power 304 can have a linear dependence 310. In some embodiments, linear dependence 310 can indicate that Raman anti-Stokes processes are a dominant source of noise photons.

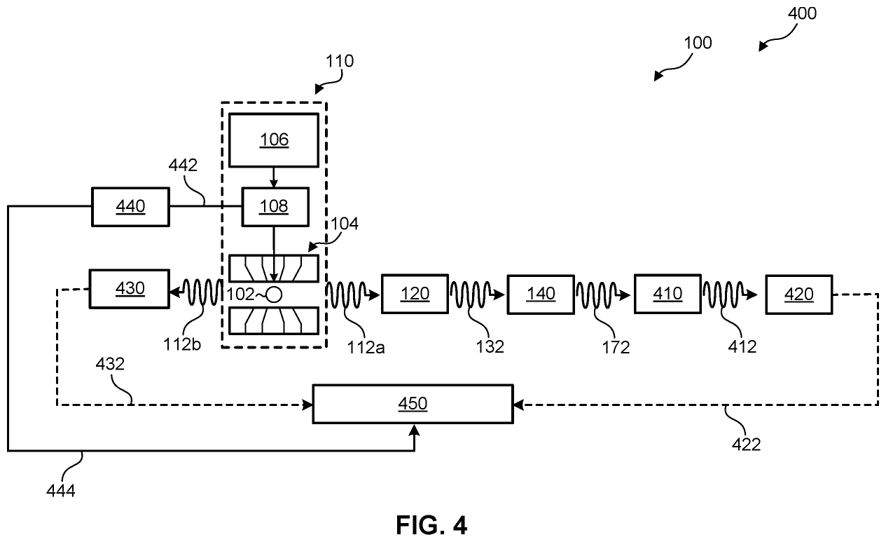

FIG. 4 illustrates quantum modem detection system 400, according to exemplary embodiments. Quantum modem detection system 400 can include a quantum modem 100, a polarization control 410, a first detector 420, a second detector 430, a controller 440, and a time tagging module 450. In some embodiments, quantum modem detection system 400 can be configured to characterize a preservation of quantum statistics after two stages of quantum frequency conversion.

As shown in FIG. 4, trapped ion stage 110 can include an ion trap 104, a trapped ion 102, a pump laser 106, and an acousto-optic modulator 108. In some embodiments, acousto-optic modulator 108 can be configured to control transmitted power of pump laser 106. In some embodiments, pump laser 106 is configured to excite trapped ion 102 to emit single photons 112a and 112b (e.g., entangled). In some embodiments, single photons 112a can be collected from a front window of trapped ion stage 110. In some embodiments, single photons 112b can be collected from a back window of trapped ion stage 110.

In some embodiments, photon 112a can undergo first quantum frequency conversion stage 120 to generate frequency converted photon 132, and then frequency converted photon 132 can undergo second quantum frequency conversion stage 140 to generate tuned O-band photon 172.

In some embodiments, polarization control 410 can be configured to change the polarization of tuned O-band photon 172 to create polarized O-band photon 412.

In some embodiments, first detector 420 can be configured to detect polarized O-band photons 412. In some embodiments, first detector 420 can include a superconducting nanowire single photon detector (SNSPD). In some embodiments, first detector 420 can be configured to send a first detector signal 422 to time tagging module 450.

In some embodiments, second detector 430 can be configured to detect single photons 112b. In some embodiments, second detector 430 can include a photomultiplier tube (PMT). In some embodiments, second detector 430 can be configured to send a second detector signal 432 to time tagging module 450.

In some embodiments, controller 440 can be configured to provide a trigger pulse to acousto-optic modulator 108 and a synchronization pulse to time tagging module 450.

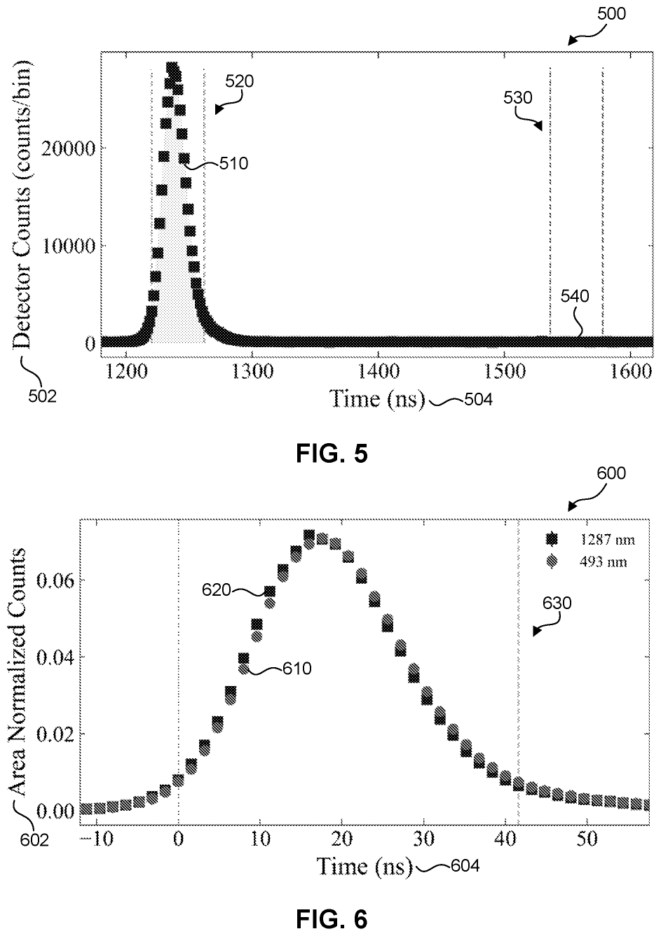

FIG. 5 illustrates time-resolved O-band photon counts plot 500 for a quantum modem (e.g., quantum modem 100), according to exemplary embodiments. Time resolved O-band photon counts plot 500 can be used to determine the signal-to-noise ratio (SNR) of quantum modem 100 (e.g., SNR of tuned O-band photon 172). Time resolved O-band photon counts plot 500 can display detector counts 502 as a function of time 504. A total number of time resolved O-band photon counts 510 that reside within photon window 520 can be calculated. In some embodiments, photon window 520 can be about 20-40 nanoseconds. Noise counts 540 can be summed over noise window 530. A signal-to-noise ratio (SNR) can be determined by dividing O-band photon counts 510 by noise counts 540.

In some embodiments, the SNR of tuned O-band photon 172 is at least 1. In some embodiments, the SNR of tuned O-band photon 172 is at least 2. In some embodiments, the SNR of tuned O-band photon 172 is at least 5. In some embodiments, the SNR of tuned O-band photon 172 is at least 10. In some embodiments, the SNR of tuned O-band photon 172 is at least 30. In some embodiments, the SNR of tuned O-band photon 172 is at least 60. In some embodiments, the SNR of tuned O-band photon 172 is at least 100. In some embodiments, the SNR of tuned O-band photon 172 is in a range of about 110 to about 165.

FIG. 6 illustrates temporal pulse shapes plot 600 of a photon emitted from a trapped ion and a photon that has undergone two stages of quantum frequency conversion, according to exemplary embodiments. For example, temporal pulse shapes plot 600 illustrates the temporal pulse shapes of photon 112 and photon 152. Temporal pulse shapes plot 600 illustrates area normalized counts 602 as a function of time 604.

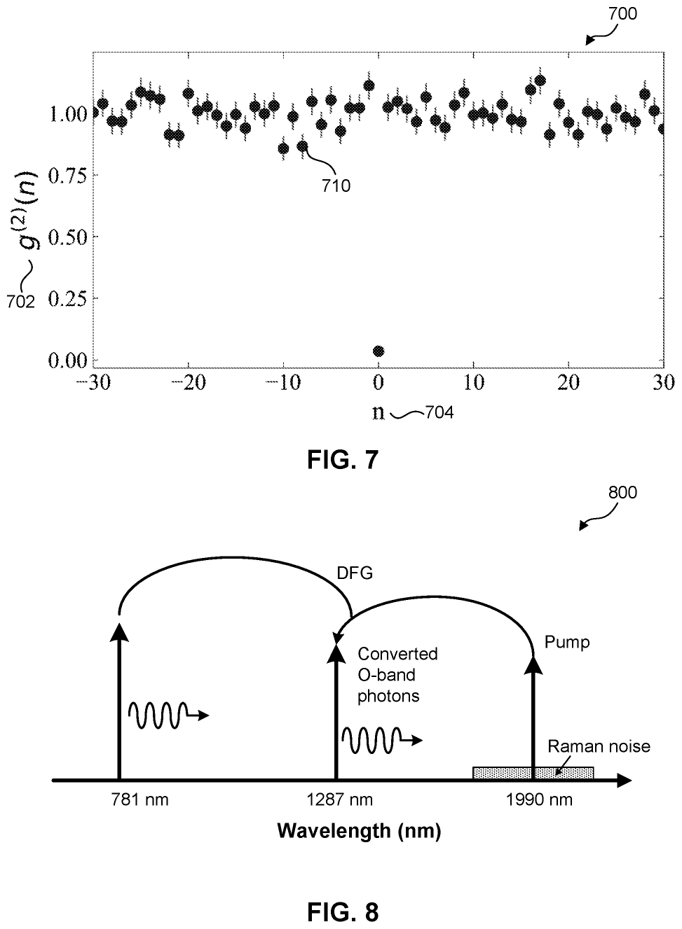

FIG. 7 illustrates a comparison of second order intensity for a photon emitted from a trapped ion and a photon that has undergone two stages of quantum frequency conversion. Second order intensity comparison plot 700 shows a normalized second order correlation function 702 as a function of the number of experimental cycles between photon detection events 704. Data points are shown with statistical error bars 710. Second order correlation function 702 yields the expected value at n=0.

FIG. 8 illustrates an exemplary second quantum frequency conversion stage diagram, according to exemplary embodiments. For example, second quantum frequency conversion stage diagram 800 embodies second quantum frequency conversion stage 140 of quantum modem 100 shown in FIG. 1. In second state quantum frequency conversion diagram 800, a 781 nm photon and a 1990 nm photon from a pump laser interact through difference frequency generation (DFG) in a non-linear medium (e.g., a PPLN waveguide) to generate a 1287 nm O-band telecommunication photon. In some embodiments, a 1990 nm photon from a pump laser can be associated with Raman noise (e.g., Raman anti-Stokes noise photons). In some embodiments, a wavelength of pump laser photons (e.g., second pump laser light 144) can be chosen such that Raman noise (e.g., Raman anti-Stokes noise photons) from the pump laser does not overlap with the wavelength of an O-band telecommunication photon (e.g., tuned O-band photon 172).

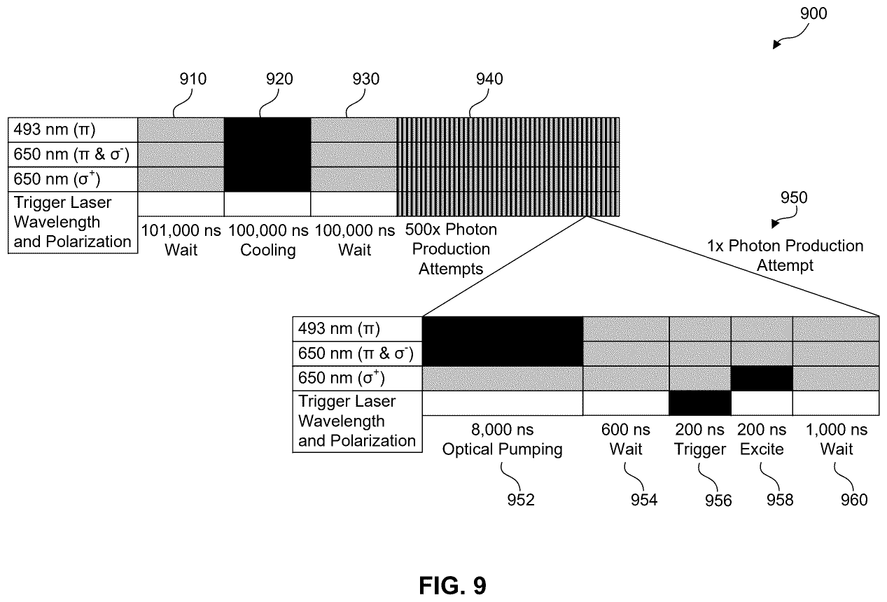

FIG. 9 illustrates an exemplary timing sequence for generating an entangled photon from a trapped ion, according to exemplary embodiments. For example, trapped ion timing sequence 900 can be used to produce a 493 nm photon from a trapped barium ion (e.g., ¹³⁸Ba⁺). Trapped ion timing sequence 900 can include a waiting step 910, a cooling step 920, a second waiting step 930, and a multiple photon production step 940. In some embodiments, cooling step 920 can include laser cooling using 493 nm π polarized light and 650 nm π, σ−, and σ+ polarized light.

As shown in FIG. 9, photon production step 940 can include multiple single photon production attempts 950. For example, photon production step 940 can include 500 single photon production attempts 950. Single photon production attempt 950 can further include an optical pumping step 952, a waiting step 954, a trigger step 956, an ion excitement step 958, and a final waiting step 960. In some embodiments, optical pumping step 952 can last 8,000 nanoseconds and can utilize 493 nm π polarized light and 650 nm π and σ− polarized light. In some embodiments, trigger step 956 can include sending a 200 ns trigger pulse to a time tagging module to act as a reference for a photon detection event. In some embodiments, ion excitement step 958 can include utilizing a 200 ns pulse of 650 nm σ+ polarized light to excite an ion into a 6P_{1/2}, mⱼ=+1/2 state from which the ion can decay into a 6S_{1/2}, mⱼ=±1/2 manifold and emit a single 493 nm photon.

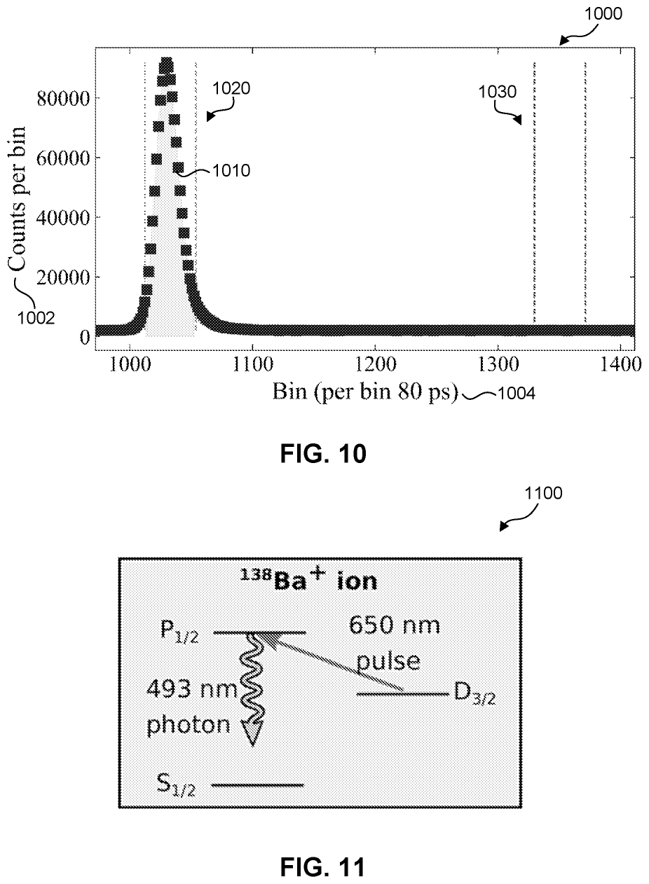

FIG. 10 illustrates an exemplary plot of time-resolved 493 nm photon counts, according to exemplary embodiments. For example, time-resolved 493 nm photon counts plot 1000 embodies photons 112b collected by second detector 430 of quantum modem detection system 400 shown in FIG. 4. As shown in FIG. 10, time-resolved 493 nm photon counts plot 1000 shows the time-resolved 493 nm photon counts per bin 1002 as a function of bin 1004 (e.g., 80 ps per bin). Time-resolved photon counts 1010 illustrate the time-resolved photon counts inside photon window 1020. Noise window 1030 is configured to count noise.

FIG. 11 illustrates an exemplary energy diagram for an S-P dipole transition of a ¹³⁸Ba+ ion, according to some embodiments. For example, energy diagram 1100 embodies the energy transition described in ion excitement step 958, as described above. In energy diagram 1100, a 650 nm pulse excites a ¹³⁸Ba+ ion in a D_{3/2} state into a P_{1/2} state, where the ion then emits a 493 nm photon as it decays into a S_{1/2} state.

### Exemplary Quantum Network and Quantum Internet

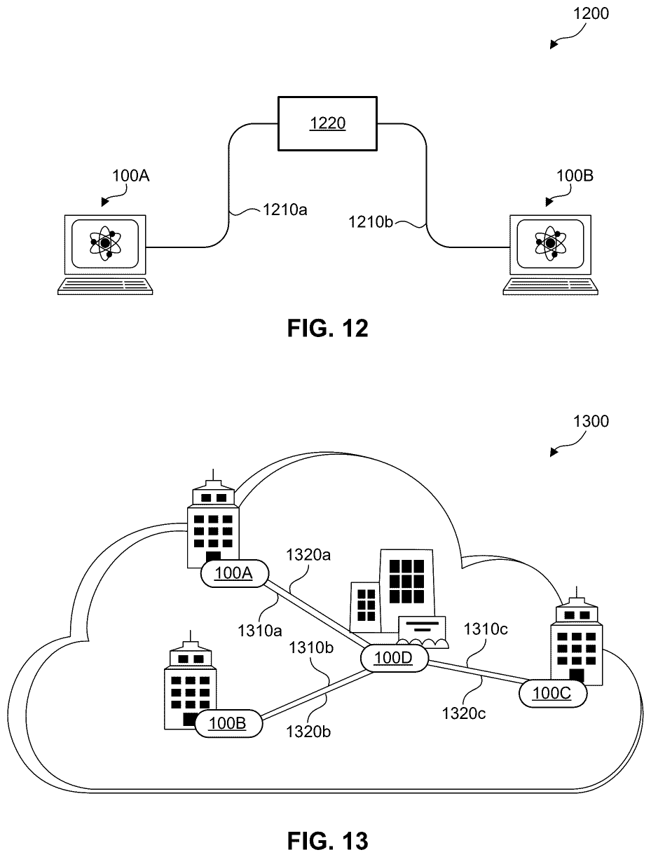

FIG. 12 illustrates an exemplary quantum network 1200, according to exemplary embodiments. Quantum network 1200 can include a first quantum modem 100A, a second quantum modem 100B, and a quantum router 1220. In some embodiments, first quantum modem 100A can include quantum modem 100. In some embodiments, second quantum modem 100B can include quantum modem 100. As shown in FIG. 12, first quantum modem 100A can be connected to quantum router 1220 through first fiber optic connection 1210a. Second quantum modem 100B can be connected to quantum router 1220 through second fiber optic connection 1210b. In some embodiments, quantum router 1220 can include a photonic integrated circuit (PIC). In some embodiments, quantum network can be configured to transmit and receive one or more entangled telecommunication photons (e.g., 1260 nm to 1675 nm), for example, between first and second quantum modems 100A, 100B across first and second fiber optic connections 1210a, 1210b (e.g., telecommunication optical fibers).

In some embodiments, quantum network 1200 can integrate (distribute) one or more qubits from one or more quantum computers via first and second quantum modems 100A, 100B. For example, first quantum modem 100A can be coupled to a first quantum computer (e.g., having 70 qubits) and second quantum modem 100B can be coupled to a second quantum computer (e.g., having 30 qubits), thereby forming a distributed quantum computing network (e.g., combined system of 100 qubits) via first and second quantum modems 100A, 100B and quantum router 1220.

FIG. 13 illustrates an exemplary quantum internet 1300, according to exemplary embodiments. Quantum internet 1300 can connect multiple quantum computers interconnected through long-range optical fibers (e.g., at least one kilometer). Quantum information can travel over existing telecommunication optical fiber infrastructure, for example, through existing telecommunication optical fibers not currently in use. In some embodiments, quantum internet 1300 can include a first quantum modem 100A, a second quantum modem 100B, a third quantum modem 100C, and a fourth (central) quantum modem 100D. In some embodiments, first, second, third, and fourth quantum modems 100A, 100B, 100C, 100D can include quantum modem 100. As shown in FIG. 13, first, second, and third quantum modems 100A, 100B, 100C can each be connected to fourth (central) quantum modem 100D through first and second pairs of optical fibers (e.g., classical optical fibers and quantum optical fibers). Classical communication fibers 1310a, 1310b, 1310c can connect first, second, and third quantum modems 100A, 100B, 100C to fourth (central) quantum modem 100D, respectively. Likewise, quantum communication fibers 1320a, 1320b, 1320c (e.g., existing optical fibers not currently in use) can connect first, second, and third quantum modems 100A, 100B, 100C to fourth (central) quantum modem 100D, respectively. In some embodiments, quantum internet 1300 can be configured for distributed quantum computing, for example, quantum computing between one or more first, second, third, and fourth quantum modems 100A, 100B, 100C, 100D.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the embodiments. Therefore, such adaptations and modifications are intended to be within the meaning and range of equivalents of the disclosed embodiments, based on the teaching and guidance presented herein.

It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

1. A system comprising:
a trapped ion, a single-photon source, or a quantum emitter configured to emit first entangled photons;
a first pump laser configured to supply second photons;
a first quantum frequency conversion device comprising a first non-linear medium and configured to interact second photons with one of the first entangled photons in the first non-linear medium to create a third photon which is entangled with the first entangled photon, wherein the third photon has a longer wavelength than the first entangled photons;
a second pump laser configured to supply fourth photons; and
a second quantum frequency conversion device comprising a second non-linear medium and configured to interact fourth photons with the third photon in the second non-linear medium to create a fifth photon which is entangled with the third photon, wherein the fifth photon has a longer wavelength than the third photon and has a wavelength in the telecommunication range (1260 nm to 1675 nm),
wherein a signal-to-noise ratio (SNR) of the fifth photon upon exiting the second quantum frequency conversion device is at least 1.

2. The system of claim 1, wherein an output of the second quantum frequency conversion device comprises the fifth photon and one or more noise photons, wherein a source of the noise photons comprises unconverted signal photons, Raman anti-Stokes noise photons, and photons from the first and second pump lasers.

3. The system of claim 2, further comprising an optical filter, a short pass filter, a long pass filter, a band pass filter, or a combination of filters configured to remove noise photons.

4. The system of claim 1, wherein the frequency of the fifth photon is at least 10 THz higher than a frequency of the second pump laser to reduce interference with Raman anti-Stokes noise photons.

5. The system of claim 1, wherein:
the first non-linear medium comprises a first waveguide in a Sagnac interferometer configuration configured to convert both orthogonal polarizations of the third photon, and
the second non-linear medium comprises a second waveguide in a Sagnac interferometer configuration configured to convert both orthogonal polarizations of the fifth photon.

6. The system of claim 1, wherein a wavelength of the first entangled photons is in the ultraviolet and visible regime of the electromagnetic spectrum.

7. The system of claim 1, wherein the fifth photon is configured to transmit quantum information a distance of at least one meter.

8. The system of claim 1, wherein the fifth photon is entangled with the emitted first entangled photon.

9. The system of claim 1, wherein temporal pulse shapes of the first entangled photons and the fifth photon overlap within experimental uncertainties.

10. The system of claim 1, wherein:
the first quantum frequency conversion device is configured to create the third photon through difference frequency generation between the first entangled photon and second photons in the first non-linear medium, and
the second quantum frequency conversion device is configured to create the fifth photon through difference frequency generation between the third photon and fourth photons in the second non-linear medium.

11. The system of claim 1, wherein the system is configured to provide an interface between a quantum computer and a fiber-optic network.

12. The system of claim 1, wherein the trapped ion comprises barium (Ba⁺), ytterbium (Yb⁺), strontium (Sr⁺), calcium (Ca⁺), or mercury (Hg⁺).

13. The system of claim 1, further comprising a high pass filter between the second pump laser and the second quantum frequency conversion device.

14. A method of generating entangled photons with wavelengths in the telecommunication range, the method comprising:
generating first entangled photons from a trapped ion, a single-photon source, or a quantum emitter;
interacting one of the first entangled photons with second photons of a first pump laser in a first non-linear medium of a first quantum frequency conversion device, thereby generating a third photon having a longer wavelength than the first entangled photons; and
interacting the third photon with fourth photons of a second pump laser in a second non-linear medium of a second quantum frequency conversion device, thereby generating a fifth photon having a longer wavelength than the third photon,
wherein a wavelength of the fifth photon is in the telecommunication range (1260 nm to 1675 nm), and
wherein a signal-to-noise ratio (SNR) of the fifth photon upon exiting the second quantum frequency conversion device is at least 1.

15. The method of claim 14, further comprising filtering the fifth photon to reduce one or more noise photons, wherein the source of the noise photons comprises unconverted signal photons, Raman anti-Stokes noise photons, and photons from the first and second pump lasers.

16. A quantum network comprising:
two or more quantum computers, wherein each quantum computer is separated from another quantum computer in the quantum network by a distance of at least one meter;
two or more quantum modems, wherein each quantum modem is coupled to a quantum computer and configured to convert emitted entangled photons produced by the quantum computer into telecommunication photons (1260 nm to 1675 nm) through one or more quantum frequency conversion devices; and
a quantum router configured to couple one quantum computer and quantum modem to another quantum computer and quantum modem through optical telecommunication fibers,
wherein the telecommunication photons have a signal-to-noise ratio (SNR) of at least 1.

17. The quantum network of claim 16, wherein the quantum network is configured for distributed quantum computing between the two or more quantum computers.

18. The quantum network of claim 16, wherein in each quantum frequency conversion device a corresponding pump laser, configured to interact with an incoming photon in a non-linear medium, creates an output photon having a frequency that is at least 12 THz higher than a frequency of the pump laser.

19. (canceled)

20. (canceled)
